(19) United States
(12) Patent Application Publication
(10) Pub. No.: US 2022/0071175 A1
(43) Pub. Date: Mar. 10, 2022

(54) Safety Release

(71) Applicant: Safety Release LLP, Palisades, NY (US)

(72) Inventors: Michael Barak, Palisades, NY (US); Fred Pulver, Northport, NY (US)

(73) Assignee: Safety Release LLP, Palisades, NY (US)

(21) Appl. No.: 17/201,558

(22) Filed: Mar. 15, 2021

Related U.S. Application Data
(60) Provisional application No. 62/990,046, filed on Mar. 16, 2020.

(51) Int. Cl. A01K 27/00

(52) U.S. Cl. CPC A01K 27/005

(57) ABSTRACT

Systems and methods to ensure the safety of pets when using a leash and collar assembly are provided. Embodiments of such systems and methods may be mechanical and/or electro-mechanical devices that allow for the safe decoupling of a pet when potentially injurious forces are applied to the leash and collar assembly. In preferred embodiments, such decoupling or release is substantially automatic based on a set of predefined jeopardy conditions.

### PRIORITY CLAIM

This application claims the benefit of U.S. Provisional Application No. 62/990,046 filed Mar. 16, 2020 which is hereby incorporated by reference in its entirety.

### BACKGROUND

Mechanical release devices for physically coupled assemblies are well known in the art. Examples of such mechanisms span many different applications and fields of use including marine applications for shipping and safety, automotive applications for hydraulic jacks and lifting cranes used in hoisting, and for construction and shipping in general. Other examples include sporting applications such as fishing or for outdoor enthusiasts that commonly use equipment such as carabiners in camping and rock climbing. In operation, release mechanisms typically employ a manual release, pin, valve or handle that allow a user to disconnect or connect one portion of the assembly to or from one another at a desired point in time—for example harness disconnect after climbing.

One form of a connected assembly commonly used is a pet leash and collar. Pet owners use collars on their pets that include a metal, oval or “O” shaped metal ring as a secure connection point that is permanently attached or anchored to the collar assembly. When an owner wishes to take their pet outside, they simply connect a leash assembly, such as a tether, rope, nylon webbing or length of leather strap, etc. through a metal clip having retractable armature at one end of the leash to the O-ring connection point on the collar assembly to create a secure connection between the leash and collar such that the animal itself cannot break free.

In some instances, however, this “unbreakable” connection between the leash and animal is not only undesirable, but is in fact dangerous, and, in some instances, deadly. Such conditions can occur, for example, when the leash is caught in an operating elevator, moving vehicle or other unforeseen or unintended circumstance that causes the application of an undesirably high stress force to the animal resulting in injury or death.

Therefore, it is an object of the invention to provide systems and methods to ensure the safety of pets when using a leash and collar assembly;

It is a further object of the invention to provide systems and methods to ensure that unintended and undesirable forces are not applied to the body of a pet when using a leash and collar assembly to prevent injury; and

It is a further object of the invention to provide systems and methods that allow a leash and collar to become automatically disconnected when a dangerous or undesirable condition occurs to prevent or otherwise minimize pet injury.

### SUMMARY OF THE INVENTION

Systems and methods to ensure the safety of pets when using a leash and collar assembly are provided. Embodiments of such systems and methods may be mechanical and/or electro-mechanical devices that allow for the safe decoupling of a pet when potentially injurious forces are applied to the leash and collar assembly. In preferred embodiments, such decoupling or release is substantially automatic based on a set of predefined jeopardy conditions. However, embodiments of the disclosed invention may include means that allow a user to customize such conditions or thresholds over time based on their experiences with their pet.

One aspect of the invention provides a pet safety mechanism attached to both a leash and a collar comprising an assembly that couples to both the leash on one end and a collar on another end that includes a force-sensitive release mechanism that decouples the leash from the collar when a pressure applied to the force-sensitive release mechanism exceeds a predetermined threshold. In some embodiments, such applied force is from a distressed pet.

Aspects of the present invention contemplate the predetermined threshold being based, at least in part, on characteristics of the pet coupled to the safety mechanism and may be user selectable. Such characteristics may be default, observed, acquired or calculated.

The force-sensitive release mechanism may be based on any suitable electronic and/or mechanical device such as a spring, electronic sensor, accelerometer or strain gauges. Certain embodiments include a processing device and a memory and may include a learning mode wherein stress/strain or other activity characteristics common with electronic exercise trackers characteristics of one or more pets are acquired as data and used as a basis for selecting an appropriate predetermined threshold or other pet safety characteristic.

In certain embodiments, the present invention may connect to a remote computer on the Internet to obtain pet safety parameters and/or keep track of an activity log for use in selecting the predetermined threshold or may be based on acquired characteristic data and configured to connect to a remote computer, tablet or mobile phone wirelessly to control or communicate with the leash release mechanism.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a general basic external view representation of the leash release mechanism of the present invention.

FIG. 2 is a general exploded view representation in accordance with an aspect of the present invention.

FIG. 3A is a more detailed representation of the internal operation of an embodiment of the present invention.

FIG. 3B is an open clasp representation of one embodiment of the present invention shown in FIG. 3.

FIG. 4 is a more detailed representation of the internal operation of another embodiment of the present invention.

FIG. 5 is an electronics block diagram constructed in accordance with one aspect of the present invention.

FIG. 6 is a representation of another embodiment of the present invention.

FIG. 7 is a more detailed representation of the internal operation of an embodiment of the present invention generally shown in FIG. 6.

### DETAILED DESCRIPTION OF THE INVENTION

Although the invention will now be described in connection with a pet leash assembly, it will be understood it may be used in substantially any urgent stress related decoupling or safety scenario or application such as those associated with sporting goods, rock climbing lifting mechanisms and other safety applications.

Veterinary and Animal Science 8 (2019) 100082 reports that stress on an animal in a collar-leash assembly begins at about 60% animal body weight and increases in severity and animal jeopardy up to full animal body weight and becomes acute at stress levels beyond animal body weight. Harness type “collar” assemblies with broad surface area (wide straps on the harness assembly across the chest area) distribute stress more evenly and thus can sustain higher loads safely as compared to neck collar assemblies, which are more dangerous.

Animals vary greatly in their ability to produce mechanical force. Small animals (dogs such as toy or small poodles) may pull in an excited state up to their body weight or somewhat above for short periods of time, but generally below, whereas other animals (dog breeds such as pit bulls, bulldogs and/or horses, oxen) can pull several times their body weight for extended periods.

Thus, it is an object of the invention to provide systems and methods that decouple when dangerous and/or unintended force is applied to a collar assembly but maintain coupling when the animal is in an excited (predatory or prey) state during otherwise “normal” conditions.

In the case of a small animal, the top-level stress created by the animal on the collar assembly should not exceed its body weight for extended periods, even in an excited state, simplifying the decoupling problem. In this case, the decoupling stress point may be initially set at e.g., 80% body weight through a simple mechanical assembly, which may further include elements designed to absorb or suppress momentarily high impulse forces above that threshold such as a piston or an expandable leash material (e.g., any spring or suitable expendable materials). With such cases, the mechanical design below may be used.

In the case of a larger animal, the top-level stress on the collar assembly will exceed animal body weight for prolonged periods during normal walking conditions, complicating the decoupling problem somewhat. In this case, two or more decoupling stress points may be required to safely maintain and decouple the animal. One way to differentiate between a jeopardy condition and a high-stress non-jeopardy situation may be based on the angle of applied stress. For example, normal animal walking conditions tend to present a stress at about 45 degrees to vertical or less, whereas high-jeopardy conditions occur at angles above about 75 degrees vertical. Thus, the initial set point of 80% body weight can be used at high angles of stress whereas low angles of stress may be set at 2× body weight or more depending on the breed or experience of the user. However, other thresholds or conditions may be used as necessary or desired based on animal type, expected stress levels and/or pre-existing data.

For example, in some embodiments of a “smart leash” in accordance with aspects of the present invention, the leash collar assembly may be put in “learn mode” where an owner walks or otherwise interacts with the animal in normal and high stress conditions and uses acquired stress data to select jeopardy thresholds and/or decoupling points. In some embodiments, such data may be uploaded to a remote computer such as a server over the Internet that analyzes the data and based on customer preferences (or substantially automatically) selects such decoupling points, which may be refined over time as more data is collected (e.g., through a subscription or other service offered by the collar manufacturer).

It will be appreciated that stress forces and torque may also vary depending on the horizontal angle of stress, for example as an animal pulls hard to the right or left in the horizontal plane the torque on other stress forces at the connection point between collar and leash will also vary and need to be accounted for.

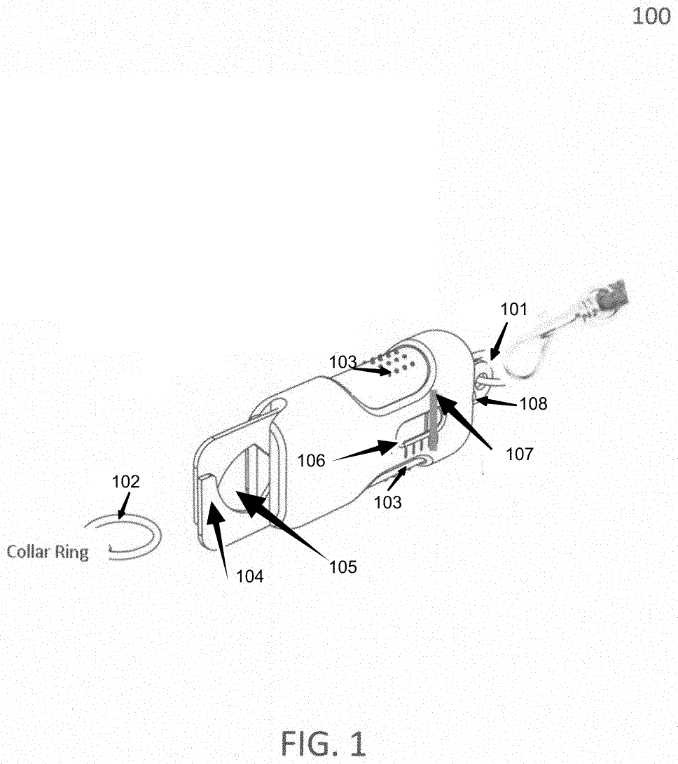

In the case of a small animal or in a situation exerting similar forces, the following simple mechanical design 100 of a leash release mechanism (LRM) in accordance with an embodiment of the invention is shown in FIG. 1. With this approach, separation force may be spring loaded and is set at the time of manufacture (or may be adjusted by the user in some embodiments). Once that threshold is exceeded, LRM 100 separates and any animal or pet is disconnected from the leash mechanism to prevent injury. In preferred embodiments, the collar remains on the animal and the leash disconnects.

The embodiment shown is suitable for deployment between a leash assembly (shown by leash clasp 101) and any suitable collar device illustrated generally by collar ring 102, which may be a metal fastening point for a neck collar, chest harness or the like (not shown). To connect collar ring 102 to LRM 100 surface(s) 103 may be squeezed together to apply an inward force (e.g., with opposing forces), thereby exerting an internal force which causes jaw portions 104 to forcibly separate allowing collar ring 102 to fit inside the space 105. When pressure on surface 103 is released, jaws 104 close and collar ring 102 is within space 105 and thus connected (not shown).

In operation, when an opposing force of a sufficient predetermined magnitude is then exerted on collar ring 102, for example, due to a struggling animal it is attached to, jaws 104 spread apart, and release collar ring 102. This force typically occurs in a situation where there is an extreme pulling force on the leash. The force required to release the collar ring is determined by certain component parts of LRM 100 such as adjustable spring settings for selectable force parameter that can be used to set the release point (such as by a user).

In some embodiments, as a pulling force is exerted, an indicator 106, may display the relative force being applied. Further embodiments may include a mechanical resettable memory sliding maximum force indicator 107, which displays the maximum force experienced while using LRM 100.

This maximum force indicator, together with a force adjustment screw 108, may be provided to allow the user to set the release force based on an initial training period.

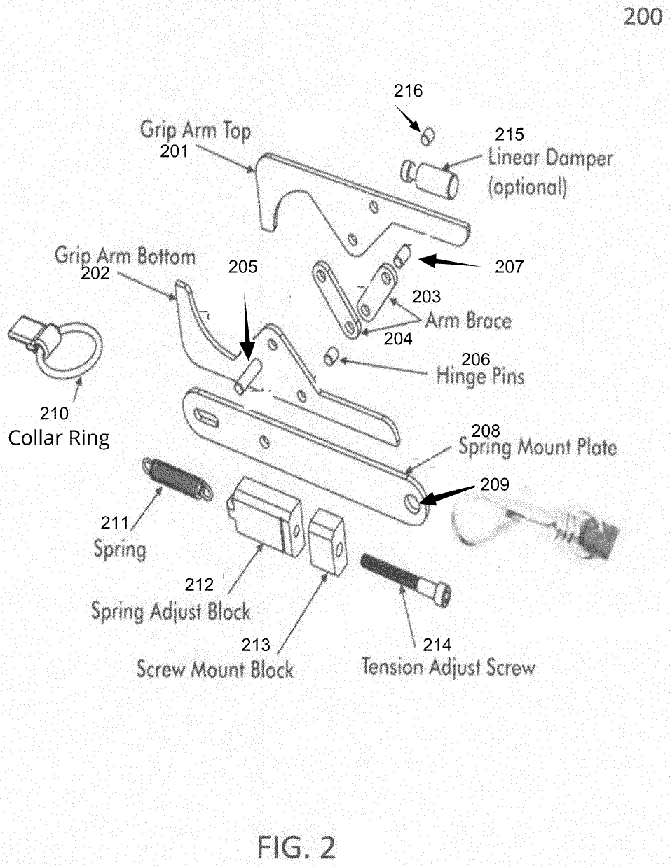

A more detailed version of LRM 100 is shown in FIG. 2 as LRM 200 which includes certain internal components. One of ordinary skill will understand such components represent an “exploded view” to depict device internals and are not necessarily to scale or shown in a particular operational configuration. As shown, LRM 200 in some embodiments may include the following components:

| | |
|---|---|
| Grip Arm Top | 201 |
| Grip Arm Bottom | 202 |
| Arm Brace A | 203 |
| Arm Brace B | 204 |
| Hinge Pin A | 205 |
| Hinge Pin B | 206 |
| Hinge Pin C | 207 |
| Spring Mount Plate | 208 |
| Leash Master End | 209 |
| Collar Ring | 210 |
| Spring | 211 |
| Spring Adjust Block | 212 |
| Screw Mount Block | 213 |
| Tension adjust Screw | 214 |
| Linear Damper | 215 |
| Linear Damper Pin | 216 |

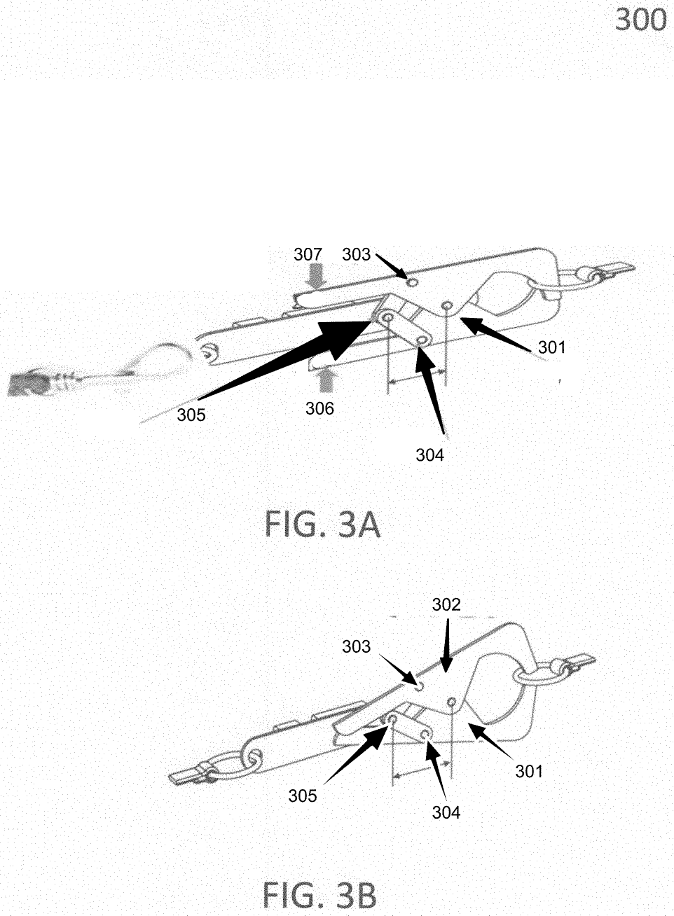

FIG. 3 depicts an assembled and operational LRM 300 based on LRMs depicted in FIGS. 1 and 2. Generally speaking, substantially the same components from LRM 200 are used in LRM 300 with corresponding reference numbers depicted where helpful to understand operation of the invention. As shown, spring mounting plate 308 extends through the horizontal center of the mechanism. Hinge pin 305 couples grip arms 301 and 302 as shown and provides a fulcrum point about which they rotate in substantially opposite directions. One end of each arm braces 303 and 304 are connected to the top and bottom grip arms by means of hinge pins at points 303 and 304. In one embodiment, the other ends of the arm braces 303 and 304 are rotationally coupled to the spring mount plate by means of a hinge pin at 307 and point 305.

Starting from a closed position, the opening of the grip arms may occur as follows. Initially, an opposing force may be exerted between each end of the mechanism. The net of this force minus the spring tension force in spring 211 is transferred to an opposing force between the hinge pins at 305 and 301. This force causes the hinge pin at 305 to move away from the 301 pin. This movement creates a resultant force between the 305 pin and the 303 and 304 pins resulting in a rotational torque on the grip arms that pivots on the pin at 301. This rotational force opens the grip arms as shown in FIG. 3B.

The grip arms may be opened by applying opposing forces at 307 and 306 that squeezes the ends of the grip arms 301 and 302 together. This causes the grip arms to pivot at the pin centered at 301 which will open the grip arms (in the opposite direction of 306 and 307). This is shown in FIG. 3B.

Conversely, starting from the open position LRM 302 may close as follows. Expansion spring 211 is attached between hinge pin at 201 and spring adjustment block 212. Spring adjustment block 212 is tied to the screw mount block 213 by means of the tension adjustment screw 214. The screw mounting block is fastened to the spring mounting plate 208. In the closed position, the tension on the spring causes a closing force to be exerted between the hinge pin at 301 and the spring mounting plate 208. This closing force translates directly to the pin at 305 which in turn creates a closing force between 305 and 301. The resultant of the closing force between 305 and 301 that forces the grip arms at point 303 and 304 apart, which in turn causes a rotational torque of the grip arms pivoting at 301, forcing the grip arms 301 and 302 to close. This is shown in FIG. 3A.

It will be understood that the foregoing design is exemplary and can be modified by those skilled in the art to include multiple springs that engage at multiple vertical angles of applied-to force such that the two-threshold system described above is achieved.

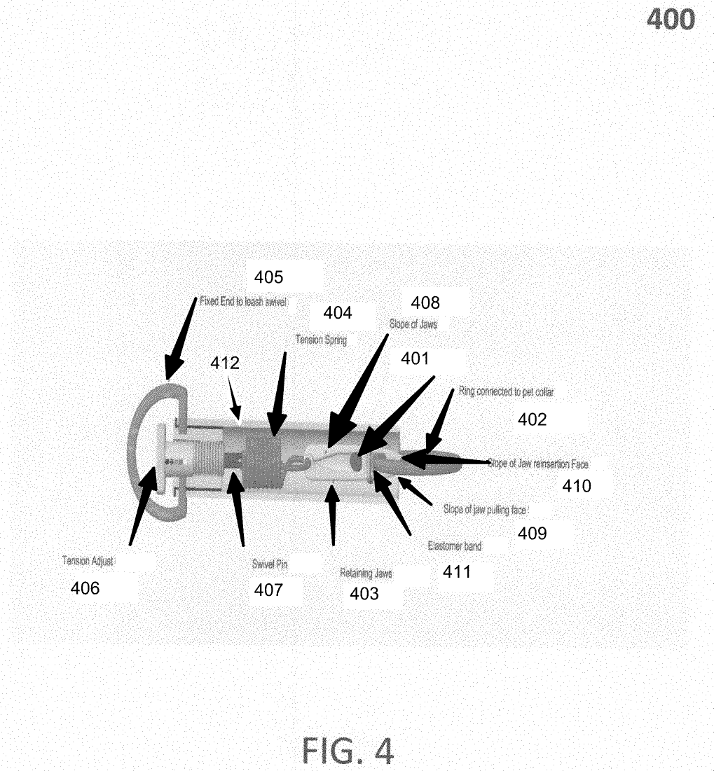

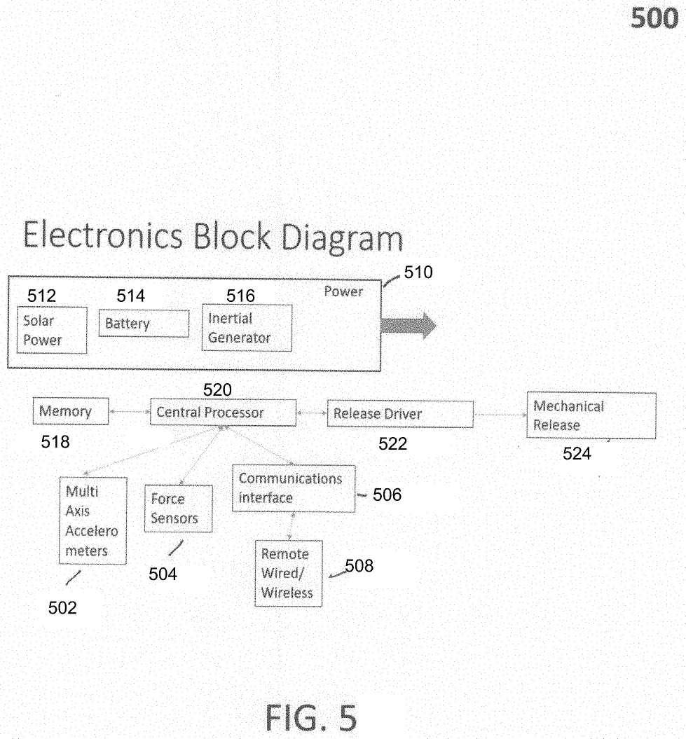

For example, another mechanical design constructed in accordance with aspects of the present invention is shown in FIG. 4 as LRM 400. Similar to the above, the leash clasp swivel that is normally connected to the pet collar may be connected to the fixed end 405. The pet collar ring is 402. An alternate is a separate swivel clasp attached in place of 402.

In the relaxed position with the jaws 403 closed, initial tension on spring 404 may pull the jaws such that 409 against pin 401. Elastomer band 411 keeps the jaws closed holding the ring 402 in place. As the tension is increased, the jaws are pulled causing the slope of the jaws 408 to ride against the pin 401 forcing the jaws to open and release the ring 402. As the jaws open, the change in angle of the pulling face 409 provides a mechanical advantage to assist in the opening.

In the relaxed state reinserting ring 402 into the jaws is assisted by the mechanical advantage jaw reinsertion face 410. Only the slight closing force of the elastomer band 411 has to be overcome. The reinsertion face angle provides the mechanical advantage to ease in the reinsertion. The spring tension that controls the release force is adjustable with the tension adjust 6. Indicator markings on the tension adjust display the relative force required to release and may be calibrated for a design. Swivel pin 407 holds the spring 404 end and allows the tension adjust to be rotated without rotating the spring. The slot in shell 412 centers the jaws in the shell when in the closed state preventing premature opening due to an angled force.

This design has certain advantages. The opening force is primarily dependent on the spring constant. There is substantially no mechanical advantage of the jaw face angle. There is substantially no open movement of the jaws until the force causes the sloped edges 408 of the jaws to reach pin 401.

More sophisticated electronic based embodiments are also contemplated by the present invention. One such embodiment may be electromechanical in nature that provides a sensing ability to sense force and/or vertical angle of applied force. For example, one such embodiment may include an electrical transducer embedded in or coupled to a collar leash assembly. This transducer may sense the pull force and activate an electro-mechanical latch through an actuator in the collar or leash to automatically decouple the pet at the desired force threshold. Such system may include a small programmable memory with a comparison capability (in either hardware and/or software) in the collar leash assembly embedded in or coupled to the transducer that includes one or more factory programmed thresholds that may be updated through a computing device such as mobile phone, tablet or PC through a direct USB or wireless connection via an application program user interface specially designed for such purpose. This approach may be used for the one separation force embodiment if desired.

For the two or more separation force embodiment, an accelerometer such as those commonly found in mobile phones or tablets may be added to the leash collar assembly to assess the angle of vertical applied force and direct the actuator to decouple at the specified force and angle thresholds, which also may come with factory default settings that may be customized by the user with an application program. The invention may also include a time component criterion such that the force and angle thresholds need to be exceeded for a minimum period of time to qualify as a decoupling event (which may be end user adjustable).

For example, one or more accelerometers may determine the relative vertical angle or applied force, differentiate between jeopardy and non-jeopardy situations based on a comparison of angle to known, customized or otherwise programmed thresholds (e.g., below or above about 70 degrees from horizontal). When the applied force as sensed by the transducer exceeds a force threshold and the angle exceeds the jeopardy threshold, the collar and leash assembly decouple, freeing the animal from the leash and/or collar and may provide an electronic alert to the user of the decoupled condition and location of the animal. Based on the sensed separation conditions, if extreme, the user may be provided with the option of alerting first responders to a potential medical situation and others around that location through a message alerting them about the lost, endangered or injured pet (pet amber alert).

In some embodiments, both force and angle setting may have emergency defaults for separation, such as when the sensed force is more than 4 times the animal body weight or when the body weight force is sensed at angle close to 90 degrees (+/−5%).

One novel transducer-based system may be in the form of a ball joint assembly, whereby a transducer is created by the male and female portions of the coupled ball joint such assembly that a variance in the electromagnetic field is used to sense pull force. When coupled with one or more accelerometers as described below, separation decisions can be made based on angle and force with the ball joint released by electromechanical actuation. Moreover, the portion of the ball joint in the leash section may be charged and when coupled the collar section, provide a charging function for the collar component.

Other examples of the present invention may not rely on a transducer but rather merely one (or more) accelerometers that sense applied force through a shearing calculation and separate based on sensed conditions. It will be understood that a single accelerometer assembly that can sense in one or more axes is contemplated by the invention. Such a circuit assembly may contain one, two or more single axis accelerometers, an actuator driver circuit, programmable memory, comparison and or processing circuitry and wireless connectivity circuitry and may be a specially designed ASIC or customized version of known “Programmable Systems on a Chip” solutions produced by companies such as Cypress or Xilinx. Such embodiments may be more power efficient as compared to the transducer embodiment. Other embodiments may include a small camera that can be activated by the end user, if desired to observe animal surroundings and may also include a speaker such that the user may audibly engage bystanders or first responders.

The invention contemplates some or all of the circuitry above may be present in either the collar or leash or divided or distributed between the two as appropriate to meet design requirements. Moreover, such a collar and leash assembly may include a power source such as battery which may need to be charged when not in use. Some embodiments may include solar cells for charging the battery during daylight hours.

Moreover, circuitry in the collar collects animal specific data which may be used for various purposes such as location, identification, health, exercise history, calorie usage as well as specifics that may be used to customize the separation thresholds described herein. Such information can be shared through the cloud with other pet custodians such as household members and veterinarians and may be processed to be provided health diet and other animal well-being recommendations including product and service recommendations.

Furthermore, such an assembly can sense whether the pet was exposed to excessive forces such as hit by a car based on accelerometer data.

Moreover, in operation, the force applied to the pet will vary based on leash geometry and layout (harness or neck collar, width of restraints, etc.). Accordingly, user may need to assess decoupling scenarios based on some initial set up based on a pet specific (breed weight, etc.) and test decoupling thresholds. Moreover, the invention contemplates “integrated” collar leash assembles that account for leash geometry and settings “out of the box.”

One example of one electromechanical system/method in accordance with the present invention may include the electronics block diagram 500, which includes sensors such as one or more multi-axis accelerometers 502 force sensors 504, communications interface 506 which may include remote, wired wireless communication links such as WiFi, Bluetooth etc. (508) power module 510 which may include solar cells 512, battery 514, generator 516 and may also include memory 518, processing device 520, release driver 522 such as a suitable actuator release and mechanical release 524. A physical release may include any suitable electromechanical device such as a motor or solenoid directly causing a mechanical release through actuation and may include a two-stage mechanism, consisting of a mechanical loaded spring activated by an electromechanical motor or solenoid type device, whereby there is a mechanical advantage between the electromechanical movement and the mechanical release. The advantage of this system is a lower power requirement than for the direct electromechanical release.

In some embodiments sensors may be of real time information and may include known mechanical or electrical strain gauges at either or both connecting ends of the LRM provide force and force profile information to a processor for calculating absolute and relative values between each strain gauge.

Multi-axis accelerometers provide positioning information, change in position information pull direction and other information related to the dynamics of the ERM's movement. This information is provided to the processor algorithms which may use this information for self-learning and/or decision making.

It is contemplated that embodiments of the present invention can communicate with other network entities. The network entities may be any or a combination of the following: A user, A wireless or wired device such as a cell phone, computer, controller, or other remote device; Communicate of a network using a specific protocol such as CAN ZigBee etc. The physical communications interface may be wired or wireless such as Ethernet, USB, Bluetooth, WiFi, etc.

The LRM of the present invention may run open source and/or hardware platform that can run a variety of software based, application, and required features. In some embodiments the software algorithms are coded sequential or recursive steps that use some, most or substantially all of the configuration, history and command data to cause the release of the holding mechanism. An example of the algorithms for controlling the hold mechanism include: a release command is received from a remote causing release, the sensor detects a force exceeding a configuration threshold causing release, the sensors detect a force exceeding a configuration threshold for a period less than the impulse configuration period resulting in the mechanism holding, training period is used to store sensor statistics and signatures. Post training period release decisions may be made based on training history. Inputs from sensors may be filtered through preset or learned statistical and predictive filters to make release decisions.

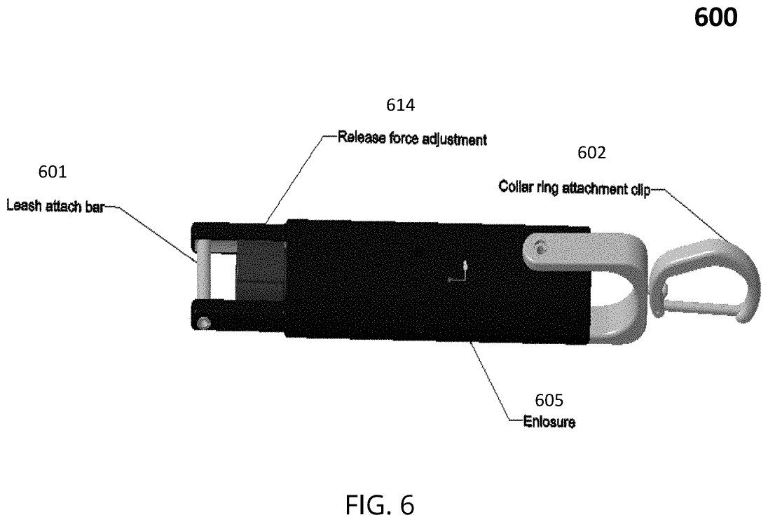

Another embodiment 600 suitable for deployment between a leash assembly and any suitable collar device illustrated generally in FIG. 6 which may be similar to LRMs 200 and 300 for fastening to a neck collar, chest harness or the like (not shown). As shown form the exterior, LRM 600 may include leash attachment bar 601, attachment clip 602, enclosure 605 and release force adjustment 614.

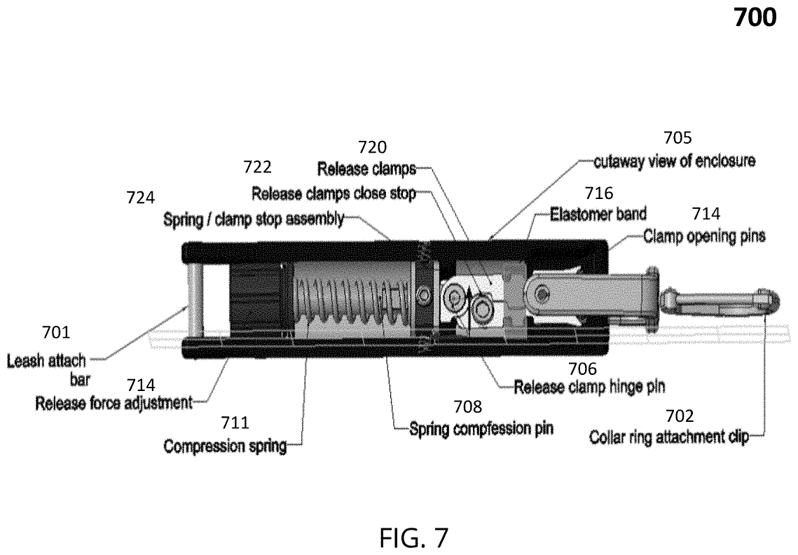

A more detailed version of LRM 600 is shown in FIG. 7 as LRM 700 which includes certain internal components. One of ordinary skill will understand such components represent an “exploded view” to depict device internals and are not necessarily to scale or shown in a particular operational configuration. As shown, LRM 700 in some embodiments may include the following components: Leash Attach Bar 701. Provides attachment structure for one end of opposing force, Leash. Release Force Adjustment 714. Adjusts the releasing force by loading spring to desired force. Compression Spring 711 provides force dependent movement of release mechanism. Spring Compression Pin Transfers opposing force at ends of mechanism to compression spring. Release Clamp Hinge Pin 706 provides hinge for release clamps to control movement. Collar Ring Attachment Clip 702, provides attachment structure for one end of opposing force, dog collar. Clamp Opening Pins 714 forces release clamps to open when clamps move over clamp opening pins. Elastomer Bands 716 allows release clamps to remain closed when force is below release threshold. Enclosure 705 provides housing and container for internal parts and provides a stop against which spring is compressed. Release Clamps 720 is a mechanism to retain collar ring clip when opposing force is below release threshold. Release Clamps close stop 722 limits clamps from closing beyond design range and prevents clamps from moving out of position when collar ring attachment clip is not inserted. Spring/clamp stop assembly 724. Provides stop for compression spring against which compression force is exerted.

All publications and patent documents disclosed or referred to herein are incorporated by reference in their entirety. The foregoing description has been presented only for purposes of illustration and description. This description is not intended to limit the invention to the precise form disclosed. Indeed, various modifications of the invention in addition to those described herein will become apparent to those skilled in the art from the foregoing description and the accompanying figures. Such modifications are intended to fall within the scope of the appended claims.

It will be understood that the release mechanisms and methods structures disclosed herein are merely illustrative and are not meant to be comprehensive or necessarily performed in the order or exact fashion shown. Persons skilled in the art will appreciate that the present invention can be practiced by other than the described embodiments, which are presented for purposes of illustration rather than of limitation, and the present invention is limited only by the claims which follow.

What is claimed is:

1. A pet safety mechanism attached to both a leash and a collar comprising:
An assembly that couples to both the leash on one end and a collar on another end that includes a force sensitive release mechanism that decouples the leash from the collar when a pressure applied to the force sensitive release mechanism exceeds a predetermined threshold.

2. The pet safety mechanism of claim 1 wherein the applied pressure is from a distressed pet.

3. The pet safety mechanism of claim 2 wherein the predetermined threshold is based, at least in part, on characteristics of the pet coupled to the safety mechanism.

4. The pet safety mechanism of claim 2 wherein predetermined threshold is user selectable.

5. The pet safety mechanism of claim 2 wherein force sensitive release mechanism is based on a spring.

6. The pet safety mechanism of claim 2 wherein force sensitive release mechanism is based on an electronic sensor.

7. The pet safety mechanism of claim 2 wherein force sensitive release mechanism is based on one or more accelerometers or strain gauges.

8. The pet safety mechanism of claim 2 further comprising a processing device and a memory.

9. The pet safety mechanism of claim 8 further comprising a learning mode wherein characteristics of one or more pets are acquired as data and used as a basis for selecting an appropriate predetermined threshold.

10. The pet safety mechanism of claim 8 that connects to a remote computer on the Internet to obtain pet safety parameters for use in selecting the predetermined threshold.

11. The pet safety mechanism of claim 10 wherein the predetermined threshold is calculated by the remote computer based on acquired characteristic data.

12. The pet safety mechanism of claim 8 configured to connect to a remote computer, tablet or mobile phone wirelessly.

13. The pet safety mechanism of claim 8 wherein the device includes a learning mode for determining the predetermined threshold.
